(19) United States
(12) Patent Application Publication
(10) Pub. No.: US 2016/0364640 A1
(43) Pub. Date: Dec. 15, 2016

(54) RADIO FREQUENCY IDENTIFICATION TECHNIQUES IN AN ULTRA-LOW TEMPERATURE ENVIRONMENT

(71) Applicant: PROMEGA CORPORATION, Madison, WI (US)

(72) Inventors: Nicholas Dachniwskyj, Fitchburg, WI (US); Mark Sehmer, Stoughton, WI (US); Daniel van der Weide, Madison, WI (US); Brian George, Brodhead, WI (US)

(21) Appl. No.: 15/147,676

(22) Filed: May 5, 2016

Related U.S. Application Data
(60) Provisional application No. 62/173,220, filed on Jun. 9, 2015.

(51) Int. Cl. G06K 19/077; G06Q 10/08

(52) U.S. Cl. CPC G06K 19/07775; G06Q 10/087

(57) ABSTRACT

A container can comprise a side wall and a radio frequency identification tag. The side wall can have inner and outside wall portions. The radio frequency identification tag can be connected to the side wall or embedded in the side wall. The radio frequency identification tag can comprise a chip and an antenna. The antenna can comprise a first antenna element and a second antenna element. The first and second antenna elements can be helically-wound around the side wall forming a 3-dimensional structure.

### RELATED APPLICATIONS

This application claims priority to and benefit of U.S. Provisional Application No. 62/173,220, filed on Jun. 9, 2015, entitled “Radio Frequency Identification Techniques in an Ultra-Low Temperature Environment,” which is hereby incorporated by reference in its entirety.

### BACKGROUND OF THE INVENTION

In general, the present disclosure relates to radio-frequency identification (RFID) communication systems. More specifically, certain embodiments of the disclosure relate to one or more methods and systems for RFID techniques in an ultra-low temperature (ULT) environment.

A ULT cold-storage device may be able to hold a relatively large number of items in corresponding containers (e.g., approximately 20,000 1-2 mL vials). Due to the large number of containers, it may be desirable to track inventory of items by maintaining a log of the given samples in a given ULT freezer.

One conventional way to track inventory employs attaching or connecting an RFID tag to each stored item and/or container (for simplicity, the term “item” encompasses the term “container” herein unless specifically indicated otherwise). As the items are placed in or removed from the ULT cold-storage device, the tags on the items must be individually and manually scanned with an RFID reader, held by a user, to electronically identify the items outside of the ULT cold-storage device. Before items are added to the ULT cold-storage device, a given item's RFID tag can be read, and the inventory list associated with the ULT cold-storage device can be updated (or alternatively, initially generated) by adding the item's information to the list. Similarly, as items are removed from the ULT cold storage device, the RFID tag must be individually read, and the inventory list can be updated (or alternatively, initially generated), by removing the item's information from the list. This technique, however, is labor intensive and time consuming since a manual RFID reading step is required every time an individual item is added or removed from the ULT cold-storage device. Failure of the user to perform this RFID reading step can cause errors in the inventory list for the ULT cold-storage device. Further, by the user repeatedly performing the scan and update steps, the inventory operation can be prone to human errors such as miscommunications, misuses, overscanning, underscanning, omitting steps, and other problems which, in turn, can be the cause of, for example, significant inventory control errors, inventory logistical planning difficulties, loss of samples or vials, missing chain of custody data, and inventory restocking delays. In addition, the longer the inventory reconciliation takes, the longer the items are not exposed to the desired ULT temperatures.

Moreover, a conventional RFID reader antenna would be unable to function accurately, consistently, and efficiently in the extreme temperatures of a ULT environment. Such an antenna is simply not physically designed to work at ULT temperatures so there is no simple way to make them work. Such an antenna needs to be designed keeping the low temperatures in mind from the beginning so that it has a resonance peak within the ultra-high frequency (UHF) spectrum, for example. In a ULT environment, such a conventional reader antenna would suffer from inaccuracies, limited range, and be unable to detect a large number of RFID-tagged items stored in the ULT cold-storage device. This is due, in part, at least to the dimensional instability of conventional antennas with temperature and the highly-reflective electromagnetic environment of the ULT enclosure.

Due to dimensional instability, a standard antenna would likely detune at about −80° C. and become less efficient. Consequently, it is desirable to have a cold-storage apparatus that can detect a high density of RFID-tagged items, for example, up to 4 vials/tags per sq. in. (including, for example, RFID-tagged items stored in a container) in a ULT environment.

Additionally, it would also be desirable to have a cold-storage apparatus that does not require additional user interaction for its operation, for example, to assess the inventory while in a ULT environment.

### BRIEF SUMMARY OF THE INVENTION

The present disclosure relates, in various embodiments, to a container. The container can comprise a side wall and a radio frequency identification tag. The side wall can have inner and outside wall portions. The radio frequency identification tag can be connected or attached to the side wall. The RFID tag may be embedded in the sidewall during vial fabrication. The radio frequency identification tag can comprise a chip and an antenna. The antenna can comprise a first antenna element and a second antenna element. The first and second antenna elements can be helically-wound around the side wall.

The present disclosure relates, in various embodiments, to at least a system that includes a plurality of shelves at least partially within at least one interior chamber of a cold-storage apparatus. Each of the plurality of shelves can be configured to support a plurality of containers. Each container can have a side wall portion and an RFID tag connected to the side wall. Each RFID tag can have an inlay. A transceiver can be in communication with the RFID inlay. The transceiver can be configured to individually and separately communicate with each of the plurality of RFID inlay forming a 3-dimensional structure.

The present disclosure relates, in various embodiments, to a system. The system can comprise a cold-storage apparatus and a plurality of shelves at least partially within at least one interior chamber of the cold-storage apparatus. Each of the plurality of shelves can be configured to support a plurality of containers. Each container can have a side wall portion and an RFID tag helically-wound around the side wall.

### BRIEF DESCRIPTION OF THE DRAWINGS

FIG. 1A illustrates a system including a cold storage apparatus, a controller, a transceiver, and a plurality of shelves supporting a plurality of containers according to one embodiment.

FIG. 1B illustrates a cross-sectional view of a system including a cold-storage apparatus, a controller, and an RFID antenna assembly, according to one embodiment.

FIG. 1C illustrates a perspective view of a box with a plurality of RFID containers according to one embodiment.

FIG. 2 is a schematic view of a container according to one embodiment.

FIG. 3 is a close-up view of a chip connected to a first antenna element and a second antenna element according to one embodiment.

### DETAILED DESCRIPTION OF THE INVENTION

The present disclosure can be understood more readily by reference to the following detailed description, drawings, examples, and claims, and their previous and following description. However, before the present compositions, articles, devices, and methods are disclosed and described, it is to be understood that this disclosure is not limited to the specific compositions, articles, devices, and methods disclosed unless otherwise specified, as such can, of course, vary. It is also to be understood that the terminology used herein is for the purpose of describing particular aspects only and is not intended to be limiting.

The following description of the disclosure is provided as an enabling teaching of the disclosure in its currently known embodiments. To this end, those skilled in the relevant art will recognize and appreciate that many changes can be made to the various aspects of the disclosure described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Reference will now be made in detail to the present preferred embodiment(s), examples of which are illustrated in the accompanying drawings. The use of a particular reference character in the respective views indicates the same or like parts.

As noted above, broadly, this disclosure teaches a system for RFID techniques in a ULT environment. The system includes a container incorporating an RFID tag. The RFID tag needs to be robust so as to operate properly at the low temperatures of the ULT (about −80° C.) and to survive the high temperatures of an in-mold labelling process. In one embodiment, the RFID tag can be configured to have an optimal performance when bent or curved to comply with the geometry of a vial or a flask. A distinguishing feature of such a tag can be that the design performance is optimized when bent or wrapped to a certain radius within the wall or on the outside surface of a ULT vial. The same tag can possibly have decreased performance if it is applied in a planar 2-dimensional fashion as a traditional flat RFID tag. Conversely, traditional flat RFID tags can suffer in performance when bent or wrapped around, for example, a vial or a flask. Moreover, planar flat RFID tags may not be able to survive such bending or wrapping.

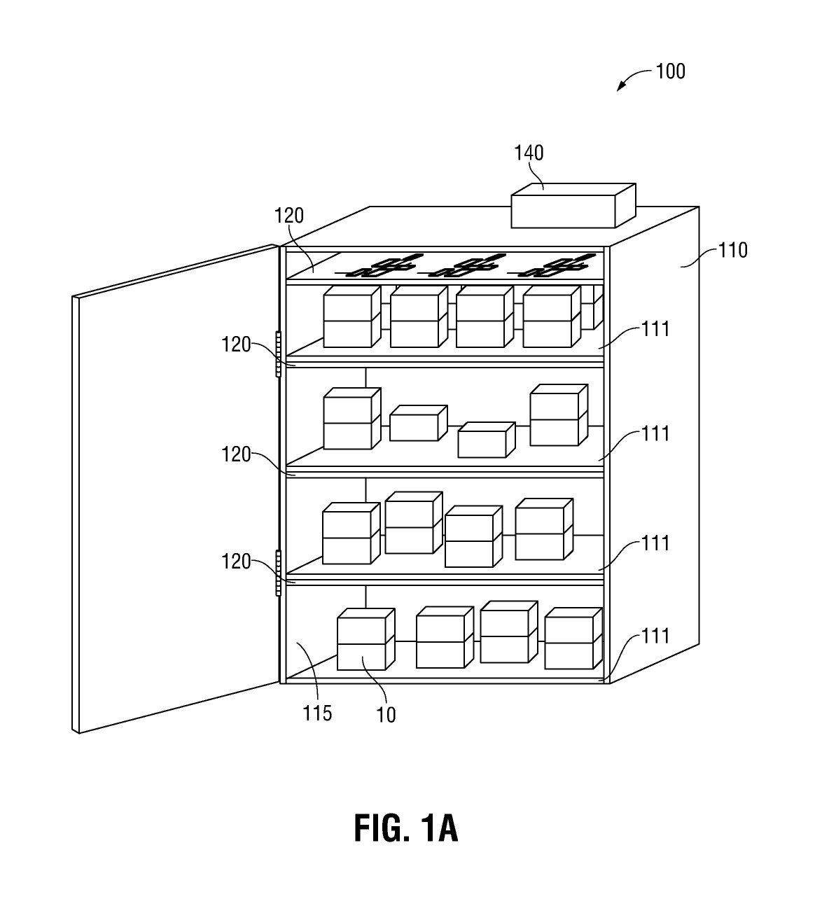

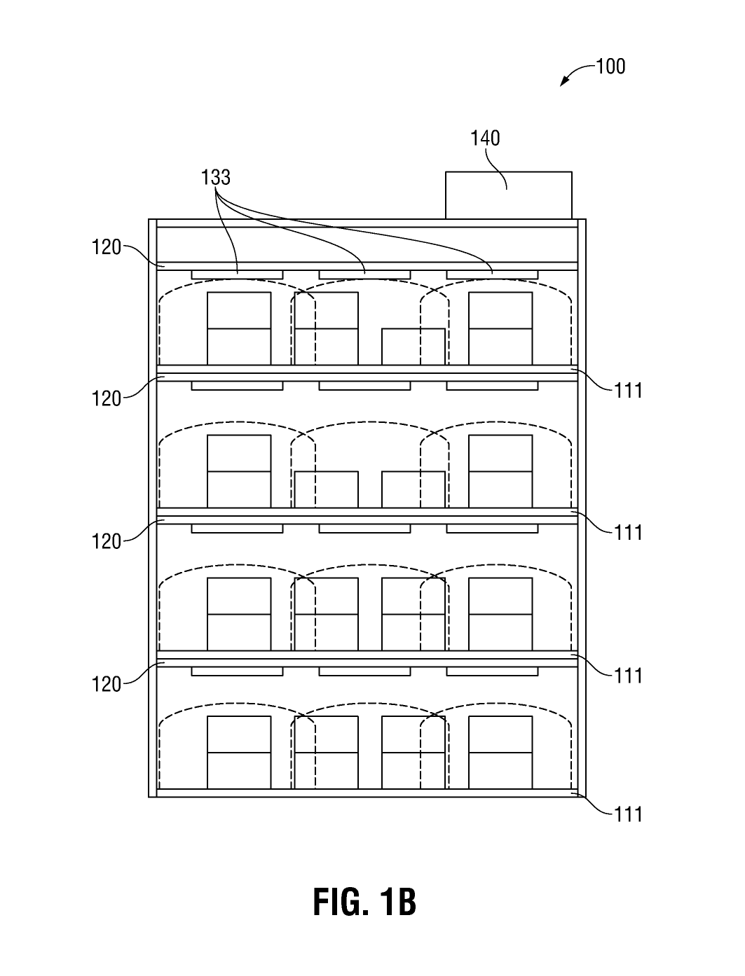

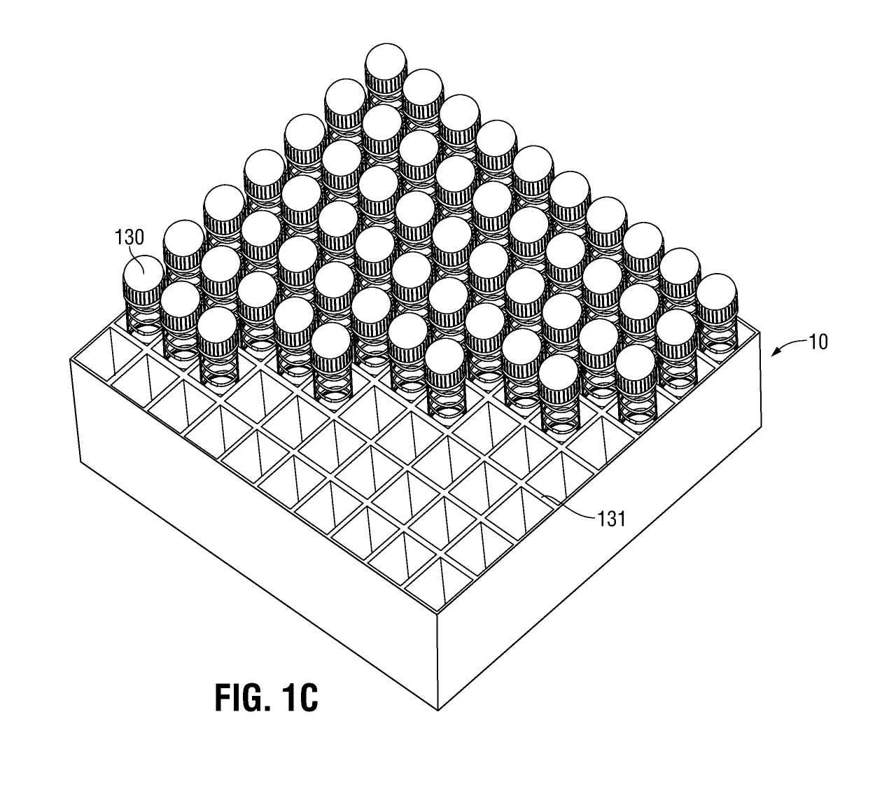

As shown in FIG. 1A, a system 100 can comprise a cold storage apparatus 110. A plurality of shelves 111 can be disposed at least partially within at least one interior chamber 115. Each of the plurality of shelves 111 can be configured to support a plurality of boxes 10, for example. Each of the plurality of shelves 111 can hold a plurality of boxes per rack. Optionally, in any embodiment, the cold-storage apparatus 110 can be configured to store the plurality of boxes 10 at a temperature between about −70° C. to about −90° C. Optionally, in any embodiment, the cold-storage apparatus 110 can be configured to store the plurality of boxes at a temperature of about −80° C.

The system 100 can further include a transceiver (or antenna) 120 and a control system 140. The control system 140 can be disposed outside the cold storage apparatus 110 as shown in FIG. 1B. The transceiver 120 can be embedded in each shelf 111 of the system and can be designed to be resonant at the center frequency of the RFID band in use (for example, about 915 MHz). The transceiver 120, furthermore, can be disposed in or configured for circular polarizations to efficiently distribute RF energy throughout the enclosure. Arrays of antennas can also be used to assist in making the RF energy throughout the enclosure more uniform. There may be a control cable and RF cable connection between the transceiver 120 and the control system 140. The control system 140 can be wired or wireless and would connect, for example, to the hospitals private network. The transceiver 120 can also be disposed outside the cold storage apparatus 110. The transceiver 120 can also include a plurality of elements, such as one or more patches 133.

FIG. 1C illustrates a box 10 containing a plurality of containers 130, such as vials or flasks. The box 10 may further include dividers 131. These dividers 131 may create grids of various sizes and shapes to accommodate various sizes and shapes of containers 130.

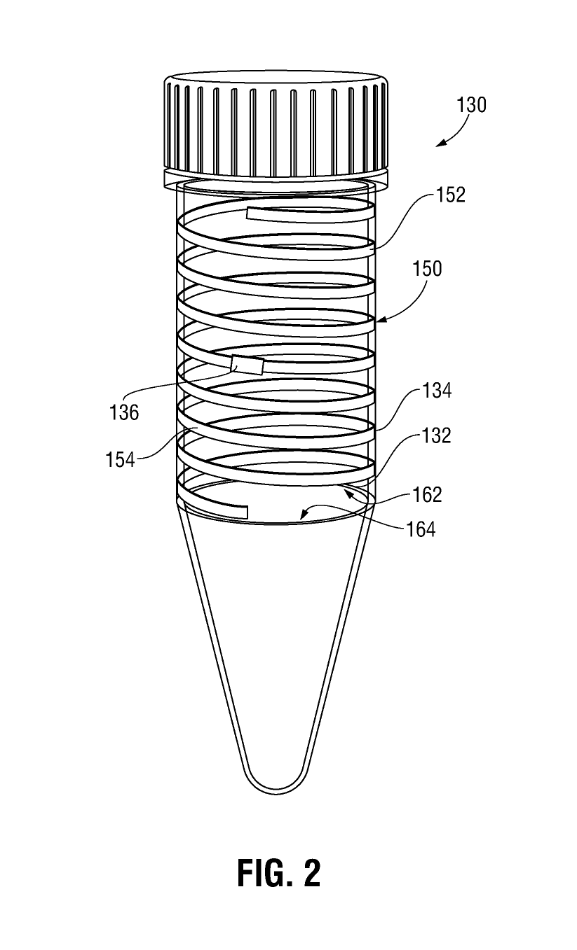

As shown in FIG. 2, each container 130 can have a side wall 132 and a radio frequency identification (RFID) tag 134. The side wall 132 can have an outside wall portion 162 and inner wall portion 164. The RFID tag 134 can be helically-wound around the side wall 132. Each RFID tag 134 can have a chip 136 and an RFID antenna 150. The chip 136 can include, for example, a processor and/or a non-transitory memory. The transceiver 120 (shown in FIG. 1) can be in communication with the RFID tags 134. The transceiver 120 can be configured to individually and separately communicate with each of the plurality of RFID tag 134. Depending on the method of interrogation from the transceiver 120, the RFID tags 134 can choose whether or not to respond to the interrogation. The transceiver 120 can also be configured to energize more than one RFID tag 134 (e.g., all of the RFID tags 134) at the same time and concurrently receive signals from the RFID tags 134. More specifically, the transceiver 120 can be in communication with the RFID antenna 150. The transceiver 120 can be configured to individually and separately communicate with each of the plurality of RFID antennas 150. The transceiver 120 can be configured to energize more than one RFID antenna 150 (e.g., all of the RFID antennas 150) at the same time and concurrently receive signals from the RFID antennas 150. The antenna or inlay 150 can include a first antenna element 152 and a second antenna element 154. The first and second antenna elements 152 and 154 can be helically-wound around the side wall 132. The helical configuration reduces or eliminates radiation blind spots that can plague traditional flat RFID tags. RFID tags may also function in any degree of orientation. In contrast, traditional tags may typically have reduced performance when placed “on edge” or perpendicular to the antenna due to the lobe field shape. The helical design of the proposed tag may create an RF field where there is no “short axis” as the cross section of such a design is circular.

The RFID antenna 150, as shown in FIG. 2, can be a right handed helix antenna. The waves that are emitted from this helical RFID antenna 150 can be right hand circularly polarized. The radiation pattern can be a maximum in the +z direction along a helix axis. Alternatively, the RFID antenna 150 can be a left handed helical RFID antenna. The waves that are emitted from this helical RFID antenna 150 can be left hand circularly polarized. The radiation pattern can be a maximum in the −z direction along the helix axis. The RFID antenna 150, as shown in FIG. 2, has about 9 turns, for example. Regardless of wind direction, the strength of the generated electromagnetic field may be equal along the +Z and −Z axis. Alternatively, the RFID antenna 150 can have more or fewer turns depending on sizes of the container 130 and length of the antennas. In addition, the spacing between each turn and antenna element width can be adjusted to optimize reception and/or transmission characteristics of the antenna. Thus, the turns can be more or less densely wrapped around the container 130.

Optionally, in any embodiment, the chip 136 and the antenna 150 of each of the plurality of RFID tags 134 can be embedded into the side wall 132 of the container 130. Alternatively, optionally in any embodiment, the chip 136 and the antenna 150 of each of the plurality of RFID tags 134 can be affixed onto surface of an outside wall portion 162 of the side wall 132 of the container 130. Further, alternatively, the chip 136 and the antenna 150 of each of the plurality of RFID tags 134 can be affixed onto surface of an inside wall portion 164 of the side wall 132 of the container 130. The chip 136 can have an operating frequency at ultra-high frequency (UHF), such as in the 900 MHz frequency band. The ultra-high frequency may have a range from about 865 MHz to about 928 MHz, for example. In one embodiment, the antenna 150 can be a quarter wavelength dipole antenna. In another embodiment, the antenna 150 can be a half wavelength dipole antenna or a short wavelength dipole antenna, for example. In another embodiment, the antenna 150 can be configured for far-field communications.

The first and second antenna elements 152 and 154 can have a total length about 6.8 inches, which may create a quarter wave dipole, for example. This length can be configured to ensure that the one or more antenna elements 152, 154 are resonant when affixed to a vial with contacting sample material. The first antenna element 152 and the second antenna element 154 can be arranged in parallel or collinear and extend in opposite directions. The first and second antenna elements 152 and 154 can be parallel to a surface of the outside wall portion 162. The inner wall portion 164 of the side wall 132 can form or substantially enclose a space configured to store an item at a temperature between about −70° C. to about −90° C., for example.

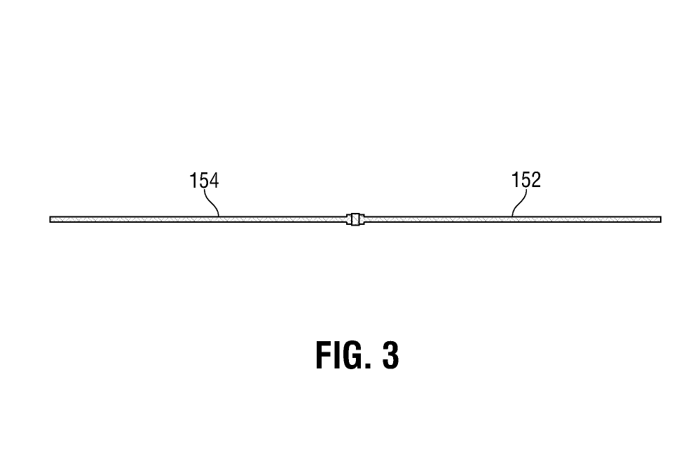

In FIG. 3, the first antenna element 152 and the second antenna element 154 may be connected to the chip 136. The first antenna element and the second antenna element may form an assembly, which may be called an inlay. The chip 136 can be on a Monza R6 strap, made by Impinj, for example. The first and second antenna elements 152 and 154 can include various layers, such as an adhesive linear backing, plastic strap, and an insulating overlay, for example. The materials were selected to perform in the intended environment.

In operation, each RFID tag can store data on its chip. The data can include, for example, one or more of the following: names of specimen contained by the container, an expiration date, a generation date of specimen, and a unique code or identifier.

To scan the RFID tags 134 inside the cold-storage apparatus 110, the antennas 120 sends electromagnetic radiation, this is received by the RFID antennas 150 of the RFID tags 134. The energy received by the RFID antennas 150 can be stored and used to power the chip 136. The chip 136 encodes the received electromagnetic radiation. Then, the encoded electromagnetic radiation is transmitted over its RFID antenna 150 back to the transceiver 120. The transceiver 120 can be connected to a reader, which can include a processor and a non-transitory memory. The reader can extract the code from the received electromagnetic radiation. The code can be used to identify, for example, a particular container 130 and its respective item contained therein. The code can be processed at the cold-storage apparatus 110, or the code can be sent over a wireless link and/or a wired link to a computer and/or central server. In one embodiment, the cold-storage apparatus 110 and the computer and/or central server are connected over a network (e.g., a private network, a cellular network, a local area network, a wireless local area network, a WiFi network, a Bluetooth network, etc.) By collecting the codes, for example, a real-time inventory can be prepared, maintained, and/or updated.

The collecting of the codes from the containers 130 inside the cold-storage apparatus 110 can occur periodically or aperiodically. For example, the transceiver 120 can be used to periodically scan the containers 130 inside the cold-storage apparatus 110 each minute, hour, day, week, etc. In addition or alternately, the transceiver 120 can be used to periodically scan the containers 130 inside the cold-storage apparatus 110 upon the fulfillment of a condition or upon the occurrence of an event (e.g., the opening or closing of the door of the cold-storage apparatus). The transceiver 120 can also be triggered by a user or user request.

In some embodiments, the RFID tags 134 can work together during their operation. Since the RFID tags 134 have helical configurations, the RFID tags 134 can act like inductors which are coupled to each other. When traditional two dimensional (2D) tags come too close together, they may begin to interfere with each other by one tag “shadowing” another by blocking the RF energy from reaching the tag. It is also possible that the individual antenna patterns of the tags may become detuned. The proposed tag design may not have these shortfalls as tags theoretically may be benefit from inductive coupling as proximity increases. In some embodiments, this is facilitated because the transceiver 120 and/or the RFID tags 134 employ the far-field portion of the electromagnetic radiation. Further, since each RFID tag 134 can encode the electromagnetic radiation returned to the transceiver 120, the transceiver 120 can concurrently energize the RFID tags 134 at and concurrently receive the encoded return electromagnetic radiation from the RFID tags 134. The circuitry coupled to the transceiver 120 such as the reader, for example, can obtain the individual codes from concurrently received encoded return electromagnetic radiation and process the codes locally or remotely to determine the present inventory of the cold-storage apparatus 110.

It will be apparent to those skilled in the art that the methods and apparatuses disclosed herein could be applied to a variety of structures having different geometries and to create selectively coated and uncoated portions of varying shapes, sizes, and orientations. It will also be apparent to those skilled in the art that various modifications and variations can be made without departing from the spirit or scope of the invention.

What is claimed is:

1. A container, comprising:
a side wall having inner and outside wall portions; and
a radio frequency identification tag connected or attached to the side wall, wherein the radio frequency identification tag comprises a chip and an antenna, wherein the antenna comprises a first antenna element and a second antenna element, wherein the first and second antenna elements are helically-wound around the side wall forming a 3-dimensional structure.

2. The container of claim 1, wherein the chip and the antenna are embedded into the side wall.

3. The container of claim 1, wherein the chip and the antenna are affixed onto surface of the outside wall portion.

4. The container of claim 1, wherein the container is a vial or a flask.

5. The container of claim 1, wherein the chip has an operating frequency at ultra-high frequency (UHF).

6. The container of claim 1, wherein the first and second antenna elements have a total length about 6.8 inches.

7. The container of claim 1, wherein the antenna is a quarter wavelength dipole antenna.

8. The container of claim 1, wherein the chip is connected to the first and second elements.

9. The container of claim 1, wherein the first antenna and the second antenna elements are collinear and extend in opposite directions.

10. The container of claim 1, wherein the chip stores data which are readable by a reader via far-field radiation.

11. The container of claim 1, wherein the inner wall portion of the sidewall form a space configured to store an item at a temperature between about −70° C. to about −90° C.

12. The container of claim 1, wherein the first and second antenna elements are parallel to the surface of the outside wall portion.

13. A system, comprising:
a plurality of shelves at least partially within at least one interior chamber of a cold-storage apparatus, wherein each of the plurality of shelves is configured to support a plurality of containers, wherein each container has a side wall and a radio frequency identification (RFID) tag connected to the side wall, wherein each RFID tag has a chip and an inlay; and
a transceiver in communication with the inlay, wherein the transceiver is configured to individually and separately communicate with each of the plurality of RFID inlay forming a 3-dimensional structure.

14. The system of claim 13, wherein each of the plurality of RFID inlay comprises a first antenna element and a second antenna element, wherein the first and second antenna elements are helically-wound around the side wall forming a three-dimensional structure.

15. The system of claim 13, wherein the chip and the inlay of each of the plurality of RFID tags are embedded into the side wall.

16. The system of claim 13, wherein the chip and the inlay of each of the plurality of RFID tags are affixed onto surface of an outside wall portion of the side wall.

17. The system of claim 13, wherein the chip of each of the plurality of RFID tag has an operating frequency at ultra-high frequency (UHF).

18. The system of claim 14, wherein each of the plurality of RFID antenna is a quarter wavelength dipole antenna.

19. The system of claim 14, wherein the first antenna and the second antenna elements of each of the plurality of RFID tags are collinear and extend in opposite directions.

20. The system of claim 14, wherein the chip of each of the plurality of RFID tags stores data which are readable by a reader via far-field radiation.
